(19) United States
(12) Patent Application Publication
(10) Pub. No.: US 2026/0177248 A1
(43) Pub. Date: Jun. 25, 2026

(54) Cooking Oven that is Well Suited for Outdoor Cooking, and Methods

(71) Applicant: Align Machine Works, LLC, Athens, GA (US)

(72) Inventors: Joseph Pruitt, Athens, GA (US); Kyle Aasness, Athens, GA (US)

(73) Assignee: Align Machine Works, LLC, Athens, GA (US)

(21) Appl. No.: 19/539,590

(22) Filed: Feb. 13, 2026

Related U.S. Application Data
(63) Continuation of application No. 18/007,538, now abandoned.
(60) Provisional application No. 63/284,328, filed on Nov. 30, 2021.

(51) Int. Cl. F24C 15/16; A47J 37/07; F24B 5/08; F24C 15/00; F24C 15/32

(52) U.S. Cl. CPC F24C 15/166; A47J 37/0718; F24B 5/087; F24C 15/006; F24C 15/322

(57) ABSTRACT

An outdoor cooking oven comprises a reconfigurable heat deflector system and independently-controllable air vents that enable the cooking oven to be configured for various cooking methods, such as low and slow cooking or grilling. At least first and second shelves are mounted within a cooking chamber with the second shelf positioned beneath the first shelf. A heat deflector system disposed on the second shelf comprises at least first and second heat deflector elements that are removable from the cooking chamber to enable a user to reconfigure the heat deflector system to vary indirect heating of food items disposed on the first shelf. At least first and second air vents disposed in a bottom side of the exterior encasement beneath the cooking chamber are independently controllable to allow at least first and second airflows from the vents to be independent varied.

### CROSS-REFERENCE TO RELATED APPLICATIONS

This application is a continuation of U.S. application Ser. No. 18/007,538 filed on Dec. 1, 2022, entitled A COOKING OVEN THAT IS WELL SUITED FOR OUTDOOR COOKING, AND METHODS, which was a U.S. National Phase Application filed under 35 U.S.C. § 371 of PCT international application number PCT/US22/51368 filed on Nov. 30, 2022, entitled “A COOKING OVEN THAT IS WELL SUITED FOR OUTDOOR COOKING, AND METHODS,” which claimed priority to and the benefit of the filing date of a U.S. provisional application having application Ser. No. 63/284,328, filed on Nov. 30, 2021, all of which are incorporated by reference herein in their entireties.

### TECHNICAL FIELD

The invention relates to outdoor cooking ovens and outdoor oven cooking methods. More particularly, the invention relates to outdoor cooking ovens and cooking methods that are well suited for slow cooking at relatively low cooking temperatures.

### BACKGROUND

A variety of charcoal ovens are used for outdoor cooking. Some charcoal ovens are designed to be used with the door open to grill meets or with the door closed to cook meats in a similar manner to the manner in which in-door ovens cook meats, but while also achieving flavors associated with cooking with charcoal.

One of the disadvantages of some known charcoal ovens designed for outdoor use is that they do not provide easy accessibility to the meats being cooked and/or to the charcoal pit. Another disadvantage of some known charcoal ovens designed for outdoor use is that the chimneys or vents through which air and smoke exits the oven are inefficient in terms of grease collecting ability and do not provide easy access to parts of the chimney or vent that collect grease for cleaning. Such chimneys or vent systems are often constructed or assembled in ways that make cleaning the grease-collecting surfaces difficult or impractical.

Another disadvantage of some known charcoal ovens designed for outdoor use is that they are limited in terms of airflow adjustability and/or temperature control. For some cooking applications, it is necessary to cook meats for long periods of time at relatively low temperatures, often referred to as “low and slow” cooking. For such applications, precise controllability of airflow and temperature are crucial. With known charcoal ovens designed for outdoor use, closure of the main door of the oven does not create an airtight seal between the door and the oven that is sufficient for efficient low and slow cooking.

Yet another disadvantage of known charcoal ovens designed for outdoor use is that they are not equipped or configured for rotisserie cooking. Rotisserie cooking has been known to be performed on charcoal grills, but not on charcoal ovens. With some charcoal grills, such as Kamado-style or kettle-style grills, the tops can be removed or opened to allow the grills to be equipped with a rotisserie spit using extra. For this purpose, additional fixtures and/or adapters are typically needed to adapt the grill for rotisserie cooking. Known charcoal ovens, however, generally do not have top surfaces that can be opened or removed to accommodate rotisserie cooking.

A need exists for a cooking oven that is well suited for outdoor use and that overcomes the aforementioned disadvantages of known charcoal ovens.

### SUMMARY

The outdoor cooking oven of the present disclosure comprises an exterior encasement, a cooking chamber disposed within the exterior encasement, at least first and second shelves mounted within the cooking chamber, a heat deflector system disposed on the second shelf, at least first and second air vents disposed in the bottom side of the exterior encasement beneath the cooking chamber and coupled to at least first and second air vent control devices, respectively, and a fuel holder for holding fuel (e.g., charcoal) disposed in between the second shelf and the first and second air vents. The exterior encasement has a left side, right side, a back side, a front side, a top side and a bottom side. The front side has a main door rotationally coupled thereto to allow the door to be rotated from a closed position of the main door to an open position of the main door, and vice versa. The main door has a handle to allow a user to rotate the main door from the closed position to the open position, and vice versa. The second shelf is positioned beneath the first shelf. The heat deflector system comprises at least first and second heat deflector elements that are removable from the cooking chamber to enable a user to reconfigure the heat deflector system to vary indirect heating of food items disposed on the first shelf. The first and second air vent control devices are accessible from outside of the exterior encasement to allow a user to set the first and second air vents, respectively, in open and closed positions and in positions in between the open and closed positions to thereby independently control at least first and second airflows, respectively, into at least first and second cooking zones, respectively, of the cooking chamber.

These and other features and advantages will become apparent from the following description, drawings and claims.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion.

FIG. 1 shows a front elevation view of the outdoor cooking oven in accordance with a representative embodiment.

FIG. 2 shows a front cross-sectional view of the outdoor cooking oven shown in FIG. 1 in accordance with a representative embodiment taken along line A-A′ showing air flowing in between the exterior encasement of the oven and thermal insulation panels of the oven that cools the exterior encasement of the oven during and after use.

FIG. 3 shows a top perspective view of the outdoor cooking oven shown in FIG. 1 in accordance with a representative embodiment with the exterior encasement of the oven removed to show the thermal insulation panels of the oven.

FIG. 4 shows a back perspective view of the outdoor cooking oven shown in FIG. 1 in accordance with a representative embodiment showing air vents disposed in a bottom portion of the exterior encasement.

FIG. 5 shows an enlarged view of an upper portion of the front cross-sectional view of the outdoor cooking oven shown in FIG. 2 showing grease baffles of the chimney of the oven and the airflow pathway through the grease baffles of the chimney.

FIG. 6 shows a front perspective view of an upper portion of the outdoor cooking oven shown in FIG. 1 in accordance with a representative embodiment with a partial exploded view of the chimney of the oven.

FIG. 7 shows a top perspective view of a removable drip pan of the chimney of the outdoor cooking oven shown in the partial exploded view of FIG. 6 in accordance with a representative embodiment.

FIG. 8 shows a front perspective view of the outdoor cooking oven shown in FIG. 1 in accordance with a representative embodiment with a slide-out drawer of the oven in an open position to show the manner in which a removable outdoor cooking pan can be easily removed from and inserted into the oven.

FIG. 9 shows a front perspective view of the outdoor cooking oven shown in FIG. 1 in accordance with a representative embodiment with a front door of the oven in an open position to show a gasket of the door that seals the oven when the door is in the closed position and to show interior features of the oven.

FIG. 10 shows the same front perspective view of the oven shown in FIG. 9, but with an indirect heating shelf shown in a pulled-out position to show indirect heating elements held on the shelf.

FIG. 11 shows the same front perspective view of the oven shown in FIGS. 9 and 10 with the indirect heating shelf and a cook surface shelf disposed above the indirect heating shelf shown in pulled-out positions.

FIG. 12 shows a side cross-sectional view of the oven shown in FIG. 9 taken along line B-B′ with the cook surface shelf shown in FIG. 9 in the pulled-out position and with the indirect heating shelf shown in FIG. 9 in the pushed-in position in accordance with a representative embodiment.

FIG. 13 shows a side perspective view of the oven shown in FIG. 1 showing a fold-out door disposed in a side of the oven having an adapter plate for attachment to a rotisserie motor when the oven is to be used for rotisserie cooking.

FIG. 14 shows a front perspective view of the oven shown in FIG. 1 in accordance with a representative embodiment with the front door of the oven in the open position to show a rotisserie spit having ends that pass thru ports disposed in opposite sides of the oven and a rotisserie motor attached to one of the ends of the spit.

FIG. 15 shows a top perspective view of the cooking oven shown in FIG. 14 in accordance with a representative embodiment with the front door of the oven in the open position to show a vertical divider slotted into charcoal grates disposed on the bottom surface of the oven to allow charcoal to be piled up in a back portion of the oven for rotisserie cooking.

FIG. 16 shows a top perspective view of the vertical divider slotted into the charcoal grates as shown in FIG. 15 for piling up charcoal in the back portion of the oven.

FIG. 17 shows a top perspective view of two vertical dividers slotted into the charcoal grates for piling up charcoal in different portions of the oven in between the dividers for prolonged cooking.

FIG. 18 shows a lower portion of the front perspective view of the cooking oven shown in FIG. 1 that shows control levers for independently controlling airflow to opposite sides of the oven.

FIG. 19 shows a bottom perspective view of two air vents that are controlled by the control levers shown in FIG. 18 for providing independently-controlled airflows to opposite sides of the oven.

FIG. 20 shows a front cross-sectional view of the cooking oven shown in FIG. 1 in accordance with a representative embodiment taken along line A-A′ showing air flowing in a circular vortex created by indirect heating in combination with airflow controllability achieved by the oven.

### DETAILED DESCRIPTION

The present disclosure discloses a cooking oven that is well suited for outdoor use and that can be configured to overcome the aforementioned disadvantages. In particular, embodiments of the cooking oven of the present disclosure provide precision control over airflow and temperature, precision control of an indirect heating configuration, easy accessibility to the food items being cooked, easy accessibility to a charcoal pan drawer for holding charcoal, and easy accessibility to parts that collect grease to allow them to be easily and thoroughly cleaned.

In the following detailed description, a few exemplary, or representative, embodiments are described to demonstrate the inventive principles and concepts. For purposes of explanation and not limitation, the representative embodiments disclose specific details in order to provide a thorough understanding of an embodiment according to the present disclosure. However, it will be understood to one having ordinary skill in the art, and having the benefit of the present disclosure, that other embodiments that depart from the specific details disclosed herein remain within the scope of the appended claims. Moreover, descriptions of well-known apparatuses and methods may be omitted to avoid obscuring the description of the representative embodiments. Such methods and apparatuses are within the scope of the present disclosure, as will be understood by those of skill in the art in view of the present disclosure.

Terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative spatial terms, such as top, bottom, upper, lower, front, back, rear, forward, up, down, left side, and right side, for example, may be used to describe the various elements'spatial relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” another element, it can be directly connected or coupled, or intervening elements may be present.

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

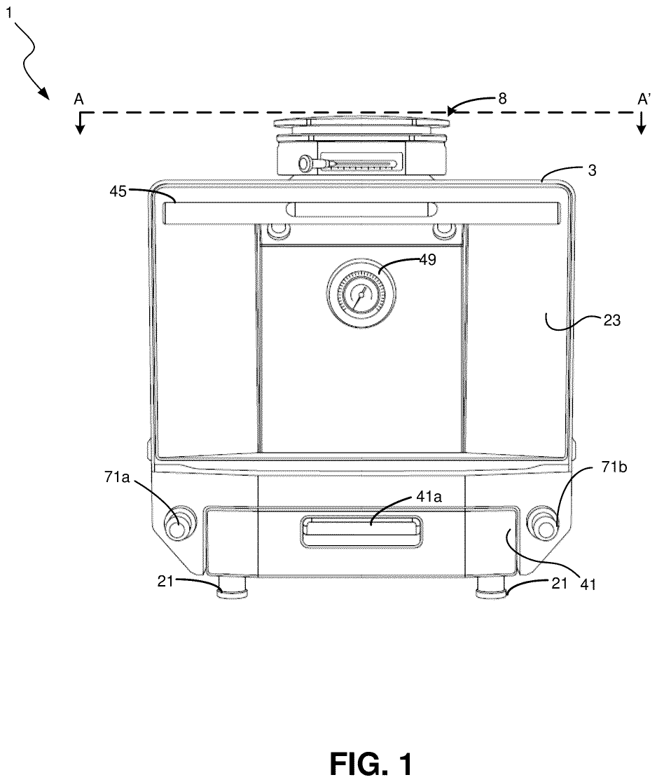

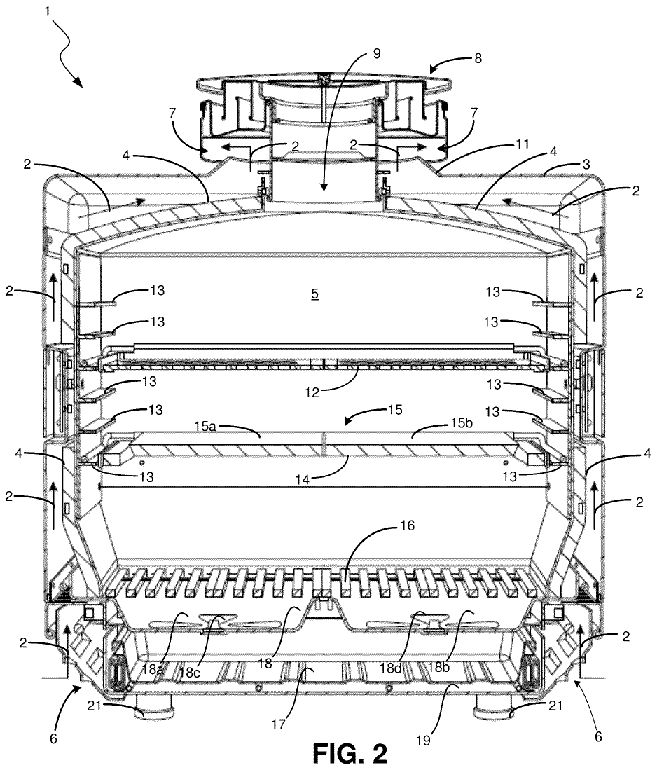

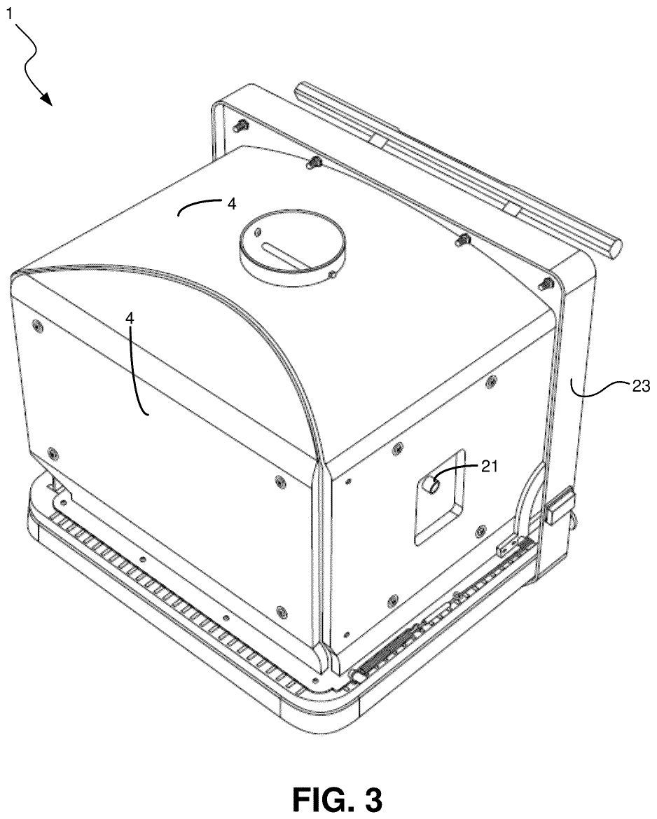

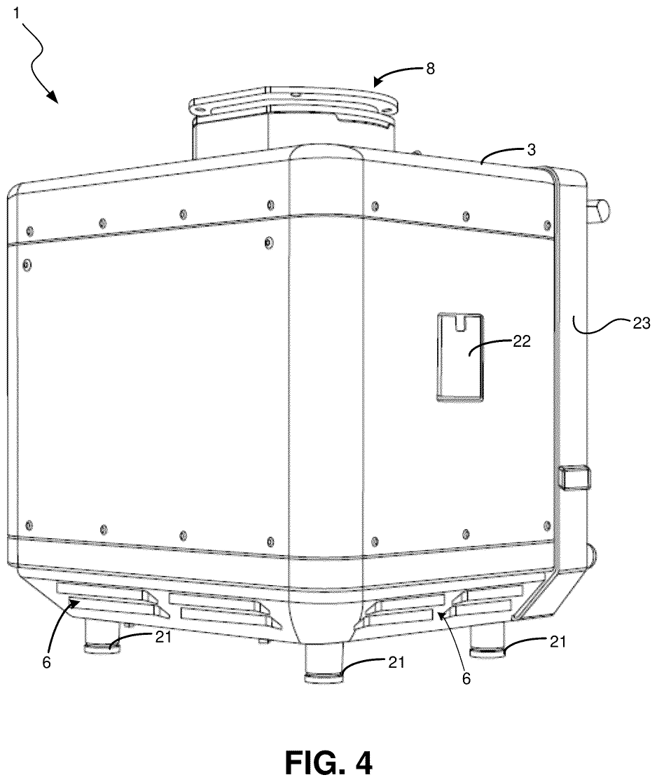

FIG. 1 shows a front elevation view of the cooking oven 1 in accordance with a representative embodiment. FIG. 2 shows a front cross-sectional view of the cooking oven 1 shown in FIG. 1 in accordance with a representative embodiment taken along line A-A′ showing air flow pathways 2 in between inner walls of an exterior encasement 3 of the oven 1 and thermal insulation panels 4 of the oven 1. FIG. 3 shows a top perspective view of the cooking oven 1 shown in FIG. 1 in accordance with a representative embodiment with the exterior encasement 3 of the oven 1 removed to show the thermal insulation panels 4 of the oven 1. FIG. 4 shows a back perspective view of the cooking oven 1 shown in FIG. 1 in accordance with a representative embodiment showing air vents 6 disposed in a bottom portion of the exterior encasement 3.

The insulation panels 4 are secured to outer surfaces of a cooking chamber 5 of the oven 1. The thermal insulation panels 4 may be made of any suitable thermal insulation material, such as a thermally insulating ceramic material, for example. The exterior encasement 3 preferably comprise a metallic material. The cooking chamber 5 preferably also comprises a metallic material. Any suitable metallic material capable of withstanding temperatures that the oven 1 can reach can be used for the exterior encasement 3 and for the cooking chamber 5.

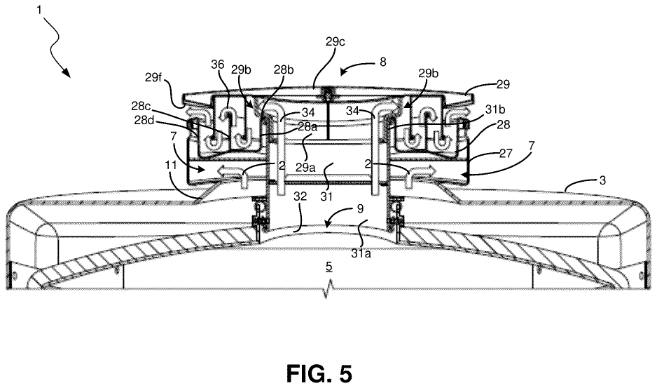

With reference to FIG. 2, air flowing along the airflow pathways 2 helps insulate and cool the exterior encasement 3 of the oven 1 during and after use. The air enters the space in between the inner walls of the exterior encasement 3 and the outer surfaces of the thermal insulation panels 4 through air vents 6 disposed along lower portions of multiple sides of the exterior encasement 3. The air flowing along the airflow pathways 2 exits the oven 1 through an air gap 7 that exists between an underside of a chimney 8 of the oven 1 and a flanged opening 11 formed in the exterior encasement 3. The flanged opening 11 is generally concentric with a ventilation outlet 9 of the oven 1 through which air and smoke from the cooking chamber 8 exits the cooking chamber 5 and then passes out of the oven 1 via the chimney 8. As air flowing along the airflow pathways 2 exits the oven 1 through the flanged opening 11 of the exterior encasement 3, it passes through the air gap 7 that exists between the top edge of the flanged opening 11 and the underside of the chimney 8, as will be described below in more detail with reference to FIG. 5. Cooling the exterior encasement 3 in this manner reduces the chance of someone being burned by touching the outer surface of the exterior encasement 3 and reduces the chance of heat from the outer surface of the encasement 3 causing a fire.

In accordance with this representative embodiment, the oven 1 has at least one cook surface shelf 12 (FIG. 2) upon which food items to be cooked can be placed. The oven 1 has a plurality of elevation racks 13 disposed on opposite sides of the interior surface of the cooking chamber 5 for slidingly engaging opposite side edges of the cook surface 12 shelf. The vertical positioning of the cook surface shelf 12 within the cooking chamber 8 can be chosen by slidingly engaging opposite side edges of the cook surface shelf 12 with the appropriate elevation racks 13. Although a single cook surface shelf 12 is shown in FIG. 2, the oven 1 can have any desired number of cook surface shelves 12 and elevation racks 13. The thermal insulation panels 4 (FIG. 3) limit the transfer of heat from the walls of the cooking chamber 5 to the exterior encasement 3, which also helps to reduce the temperature of the exterior encasement 3.

In accordance with this representative embodiment, the oven 1 has at least one indirect heating shelf 14 (FIG. 2) upon which at least one indirect heating element 15 is placed. The elevation racks 13 disposed on opposite sides of the interior surface of the cooking chamber 5 are also used for slidingly engaging opposite side edges of the indirect heating shelf 14. The vertical positioning of the indirect heating shelf 14 within the cooking chamber 5 can be chosen by slidingly engaging opposite side edges of the shelf 14 with the appropriate elevation racks 13. Although a single indirect heating shelf 14 is shown in FIG. 2, the oven 1 can have any desired number of indirect heating shelves 14, although typically only a single indirect heating shelf is needed.

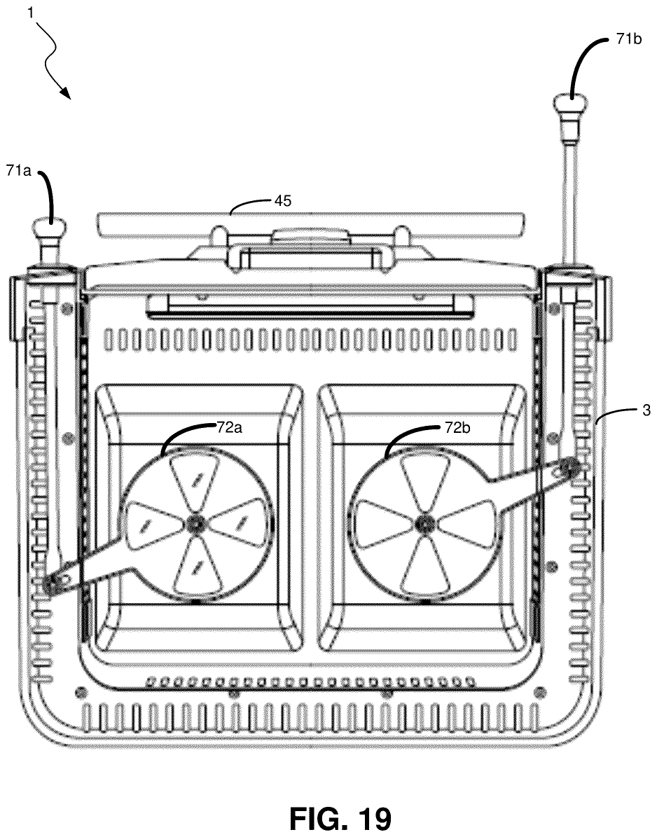

The indirect heating shelf 14 is configured to hold a heat deflector system 15, which may comprise one or more heat deflector elements made of a suitable material for absorbing and radiating heat (e.g., a suitable ceramic material). One or more charcoal grates 16 are removably positioned on support surfaces near the bottom interior surface of the cooking chamber 5 above first and second independently controlled air vents, which are not visible in FIG. 2, but are shown in FIG. 19 and described below in detail. Heat generated by burning fuel located in a removable fuel pan 17 disposed in a separate drawer beneath the grates 16 directly heats the heat deflector system 15, but does not directly heat the cook surface shelf 12. As the heat deflector element(s) 15a and 15b of the system 15 are heated, they deflect heat and thereby result in indirect heating of food items located on the cook surface shelf 12.

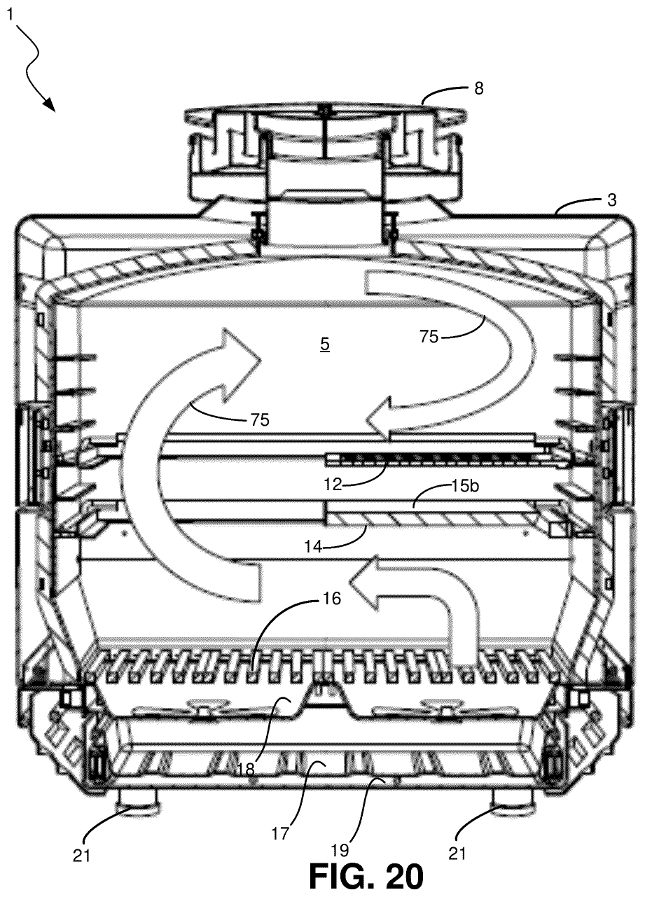

Preferably the heat deflector system 15 comprises at least first and second removable heat deflectors 15a and 15b, respectively, that are removably positioned side-by-side in the widthwise direction of the cooking chamber 5 as shown in FIG. 2. However, any number, N, of heat deflector elements could be used in the system 15, where N is a positive integer that is greater than or equal to one and preferably is greater than or equal to two. The heat deflector system 15 and its usage is discussed below in more detail with reference to FIG. 20.

A bottom surface 18 of the cooking chamber 5 that is disposed beneath the grates 16 preferably has two adjacent concaved regions 18a and 18b that have respective air vents 18c and 18d formed therein to allow heat and smoke generated by burning charcoal contained in the removable charcoal pan 17 to pass through the vents 18c and 18d into the cooking chamber 5. Preferably the fuel pan 17 is seated in a separate pull-out drawer 19 that is external to the cooking chamber 5. The drawer 19 preferably is in sliding engagement with interior features of the exterior encasement 3 to enable the drawer 19 to be placed in a pulled-out position in which the removable fuel pan 17 can be easily accessed or in a pushed-in position in which a front surface of the drawer 19 is generally flush with a front surface of the exterior encasement 3. It should be noted that although the fuel that is held in the pan 17 is typically charcoal, any suitable type of fuel may be used, including, for example, wood, fuel pellets, gas, etc.

The gratings 16 provide a cooking surface for direct heating of food items (e.g., searing) while the cook surface shelf 12 disposed above the heat deflector system 15 provides a cooking surface for indirect heating of food items, e.g., low and slow cooking and smoking of food items.

As shown in FIGS. 1, 2 and 4, preferably the lower portions of the sides of the exterior encasement 3 where the vents 6 are located slant inwardly. Slanting the lower portions of the sides inwardly serves two purposes, namely, (1) it aligns the airflow pathways 2 with the gap between outer surfaces of the thermal insulation panes 4 and the inner surfaces of the exterior encasement 3; and (2) it reduces the width-by-length footprint of the oven 1 and allows the legs 21 of the oven 1 to be located closer to one another, thereby allowing placement of the oven 1 on a smaller support surface. The air vents 6 preferably are location on lower portions of the left and right sides and back side of the exterior encasement 3.

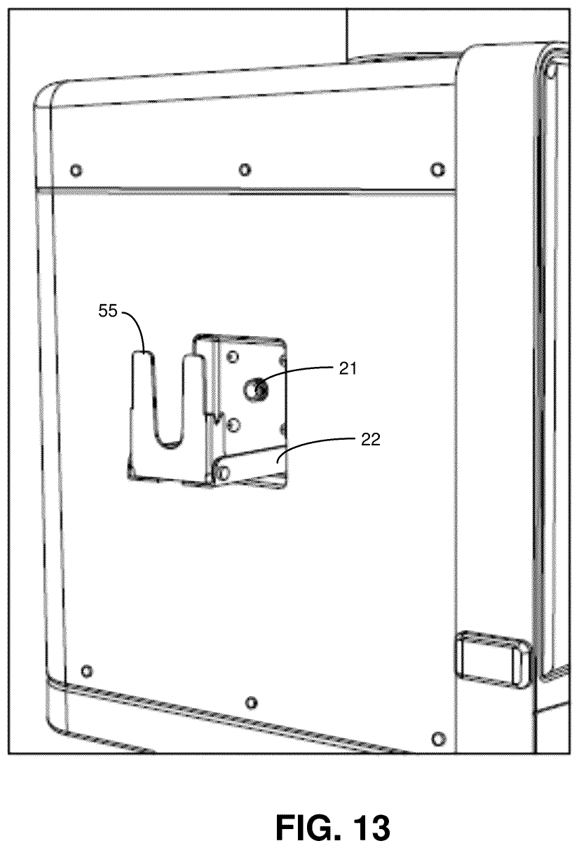

With reference to FIG. 4, a fold-out door 22 disposed in the right side of the exterior encasement 3 can be seen in its folded state in which it is generally flush with the right side of the encasement 3. An identical fold-out door 22 is disposed in the opposite, left side of the exterior encasement 3. As will be described below in detail with reference to FIGS. 13-15, these doors 22 can be placed in unfolded states to provide access to ports in the right and left sides of the oven to allow a spit to be passed through the ports and supported by features of the unfolded doors 22 and to support a rotisserie motor for turning the spit. One of the ports 21 can be seen in FIG. 3. These ports 21 and the fold-out doors 22 allow the oven 1 to be used for rotisserie cooking, as will be described below in more detail.

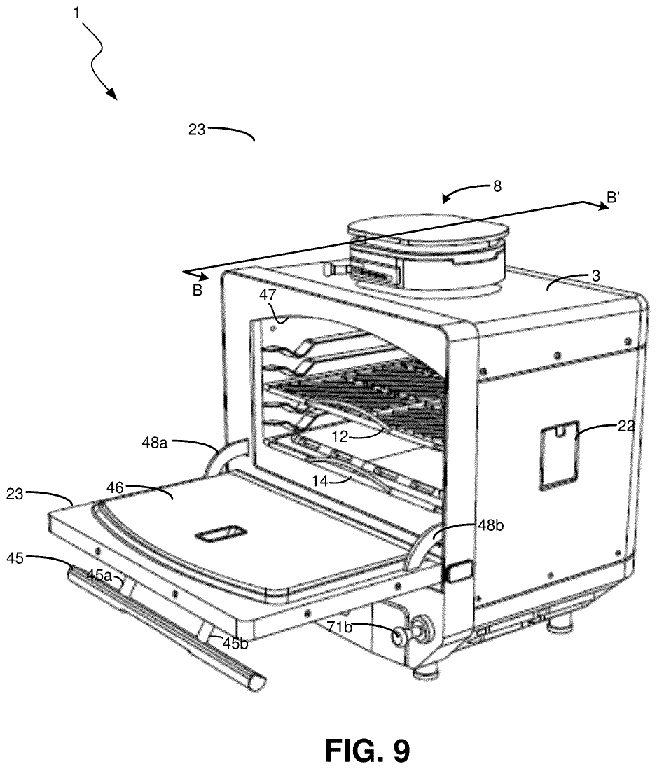

A front door 23 of the oven 1 is coupled to the front side of the oven 1 by hinges that couple the lower edge of the door 23 to opposite sides of the encasement 3 to allow the door 23 to be rotated in the downward direction to open the door 23 and to be rotated in an upward direction to close the door 23. More details of the door 23 will be discussed below with reference to FIG. 9.

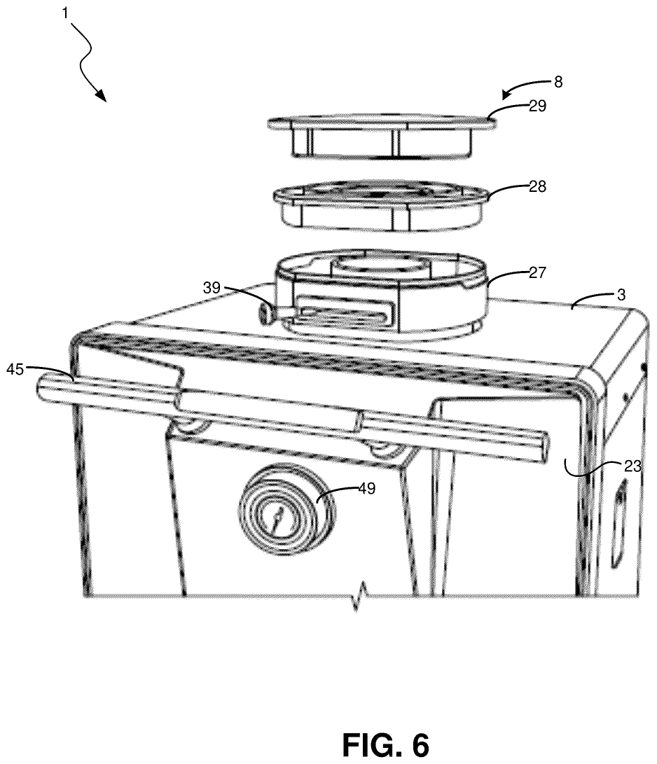

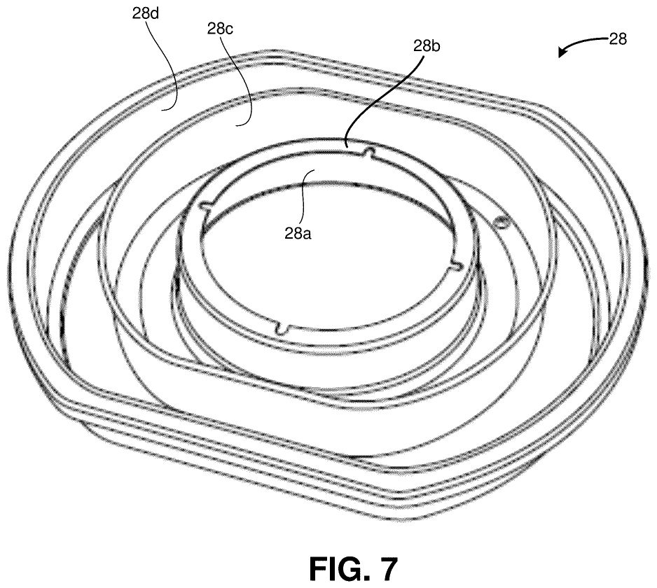

An exemplary or representative embodiment of the chimney 8 of the oven 1 will now be described with reference to FIGS. 5-7. It should be that the inventive principles and concepts are not limited to the oven 1 utilizing the chimney 8 shown in the figures, but configuration of the chimney 8 is preferred due to the benefits and advantages that are achieved through its use. FIG. 5 shows an enlarged view of an upper portion of the front cross-sectional view of the cooking oven 1 shown in FIG. 2 showing grease baffles 25 of the chimney 8 of the oven 1 and the airflow pathway 26 through the grease baffles 25 of the chimney 8. FIG. 5 also shows the airflow pathway 2 shown in FIG. 2 as it passes through the air gap 7 between the underside of the chimney 8 and the top edge of the flanged opening 11 of the exterior encasement 3. FIG. 6 shows a front perspective view of an upper portion of the cooking oven 1 shown in FIG. 1 in accordance with a representative embodiment with a partial exploded view of the chimney 8 of the oven. The different components comprising the chimney 8 are visible in the exploded view. The components of the chimney 8 include a chimney base 27, a chimney grease bowl 28 and a chimney cap 29. FIG. 7 shows a top perspective view of the chimney grease bowl 28 shown in the exploded view of FIG. 6.

With reference first to FIGS. 5 and 7, a proximal end 31a of a hollow tubular portion 31 of the chimney base 27 fits inside of and is fixedly secured to a lip 32 of the cooking chamber 5 that defines the generally circularly-shaped exhaust outlet 9 of the cooking chamber 5. A relatively short hollow tubular portion 29a of the chimney cap 29 fits inside of and is removably secured to the inner surface of the distal end 31b of the hollow tubular portion 31 of the chimney base 27. A first generally circular wall 28a of the grease bowl 28 that extends upwardly away from an inner bottom surface of the grease bowl 28 has a flange 28b that sits on the distal end 31b of the hollow tubular portion 31of the chimney base 27 and is sandwiched in between the chimney cap 29 and the distal end 31b of the hollow tubular portion 31 of the chimney base 27. The chimney base 27, the chimney cap 29 and the grease bowl 28 are sized and shaped to allow them to be removably secured to one another through a friction fit, although other types of coupling arrangements could be used for this purpose, as will be understood by those of skill in the art.

The chimney cap 29 has a vented region 29b just above the hollow tubular portion 29a of the chimney cap 29 and just below the top surface 29c of the chimney cap 29 through which air and smoke represented by arrows 34 in FIG. 5 passing out of the exhaust outlet 9 of the cooking chamber 5 passes. A second generally circular wall 28c of the bowl 28 that encircles the first generally circular wall 28a of the bowl 28 extends upwardly away from the inner bottom surface of the bowl 28. A third generally circular wall 28d of the bowl 28 that encircles the first and second generally circular walls 28a and 28c, respectively, extends upwardly away from the inner bottom surface of the bowl 28. These three walls 28a, 28c and 28d form a portion of a grease baffle, as described below in further detail.

With reference to FIG. 6, the chimney cap 29 has first and second generally circular walls 29d and 29e, respectively, that extend downwardly away from the top surface 29c of the chimney cap 29 toward the inner bottom surface of the grease bowl 28. As seen in FIG. 5, the walls 28a, 28c and 28d are interleaved with the walls 29d and 29e. Because of the circular nature of these walls, they cooperate to provide a 360° grease baffle and firebreak. Due to the number of walls, the air, which is represented by arrows 136, is required to make three approximately 180° turns before exiting the air gap 137 in between the top of wall 28d and the underside 29f of the top surface 29c of the chimney cap 29. This causes a lot of the grease that is contained in the air to collect on the walls 28a, 28c, 28d, 29d and 29e and drain down onto the inner bottom surface of the grease bowl 28.

The grease bowl 28 and the chimney cap 29 can easily be removed from the chimney base 27 and separated from one another and cleaned to remove the grease and any dirt or grime. Traditional chimneys used in cooking ovens generally contain a labyrinth of geometry that makes thorough cleaning difficult or impossible. With the chimney 8 of this representative embodiment, the entire surface area of the chimney is easily accessible for cleaning, which results in better control over air ventilation for better cooking. It should be noted that the chimney 8 is not limited to having a grease baffle that achieves any particular number of turns for the air passing through it. The grease baffle of the chimney 8 achieves at least M turns of about 180°, where M is a positive integer that is greater than equal to one, and preferably is greater than or equal to three. The chimney base 27 preferably also has an air vent control lever 29 that is slidable within an opening to increase or decrease the rate of flow of the air 34 passing from the cooking chamber 5 through the chimney 8.

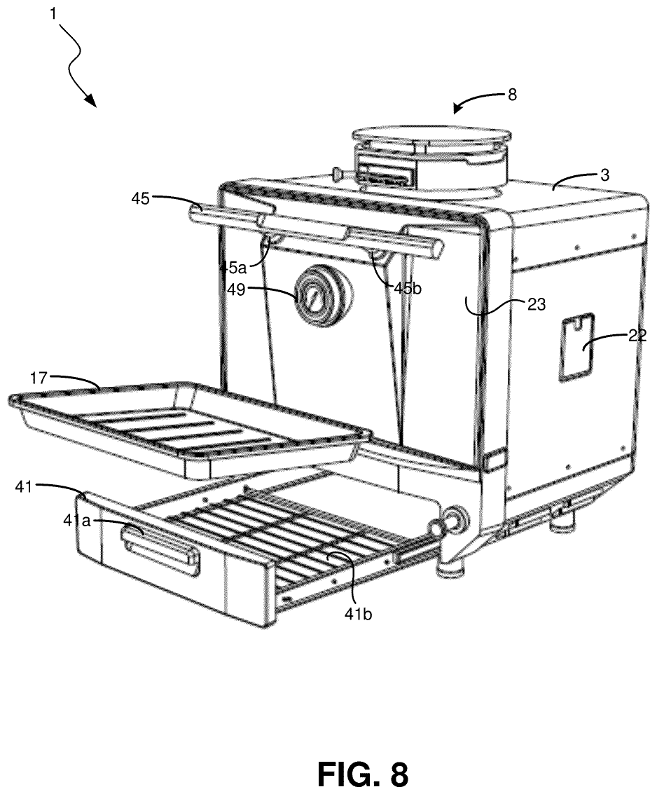

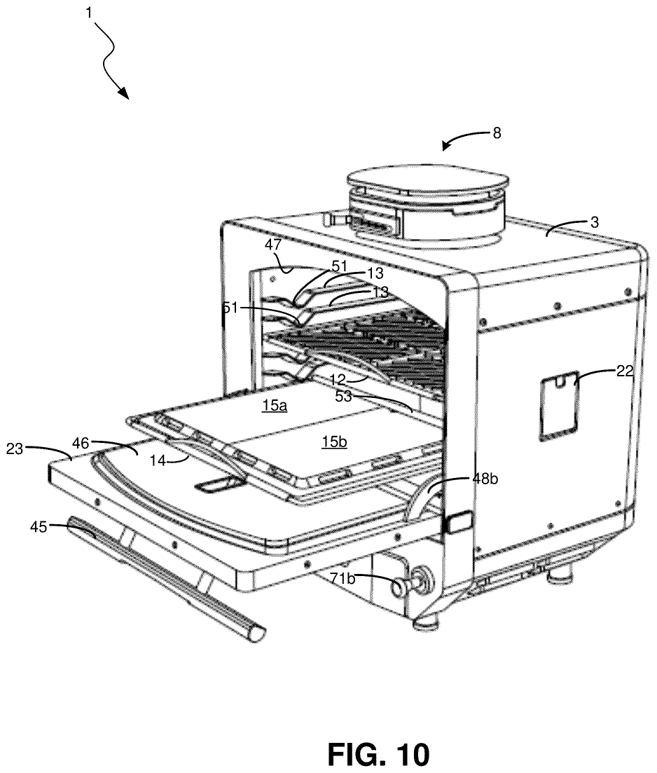

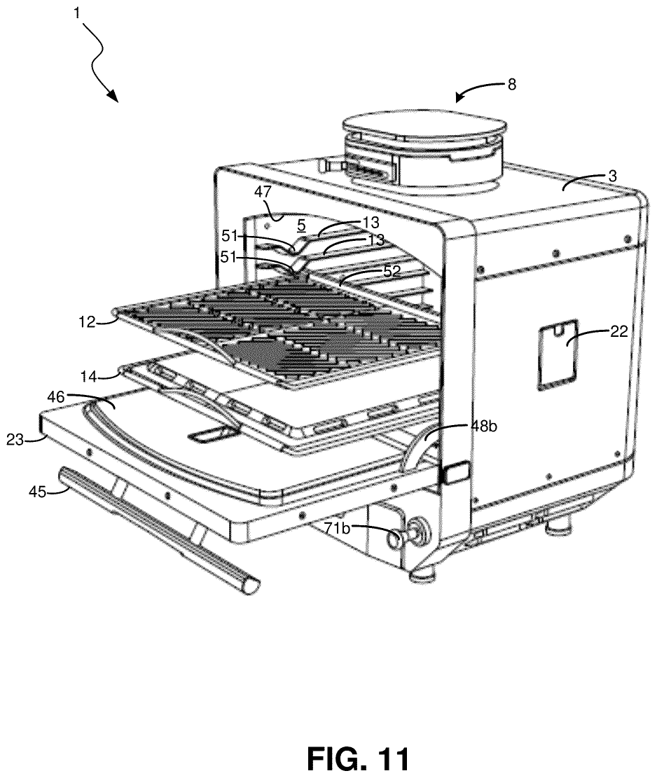

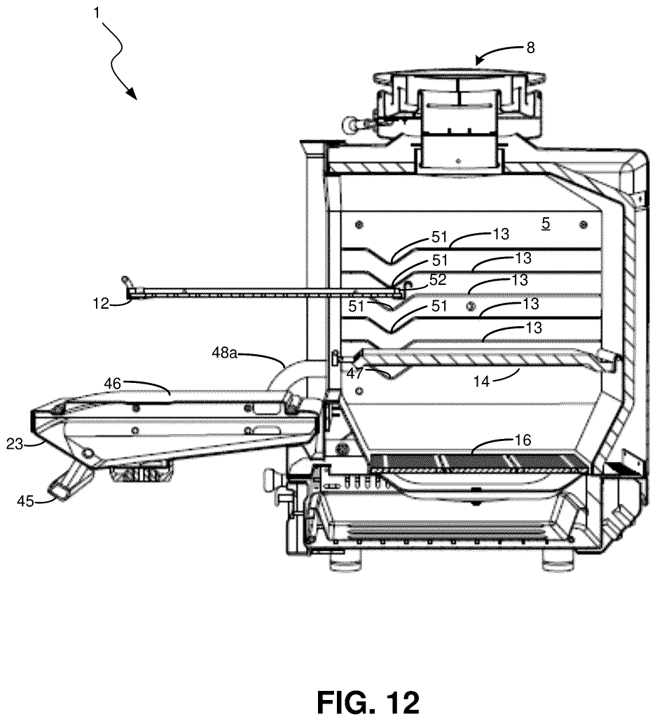

FIG. 8 shows a front perspective view of the cooking oven 1 shown in FIG. 1 in accordance with a representative embodiment with the pull-out fuel drawer 19 of the oven 1 in an open position to allow a removable pan to be easily removed from and inserted into the oven 1. FIG. 9 shows a front perspective view of the cooking oven 1 shown in FIG. 1 in accordance with a representative embodiment with the front door 23 of the oven 1 in an opened position to show a gasket 42 of the door 23 that seals the oven 1 when the door 23 is in the closed position. FIG. 10 shows the same front perspective view of the cooking oven 1 shown in FIG. 9, but with the indirect heating shelf 14 shown in a pulled-out position to show two indirect heating elements 15a and 15b held on the shelf 14. FIG. 11 shows the same front perspective view of the cooking oven 1 shown in FIGS. 9 and 10 with both the indirect heating shelf 14 and the cook surface shelf 12 in pulled-out positions. FIG. 12 shows a side cross-sectional view of the cooking oven 1 shown in FIG. 9 taken along line B-B′ with the cook surface shelf 12 in the pulled-out position and with the indirect heating shelf 14 in the pushed-in position in accordance with a representative embodiment.

As indicated above, the pull-out fuel drawer 19 preferably is in sliding engagement with interior features of the exterior encasement 3 to enable the drawer 19 to be placed in a pulled-out position in which the removable fuel pan 17 can be easily accessed or in a pushed-in position in which a front surface of the drawer 19 is generally flush with a front surface of the exterior encasement 3. This allows charcoal or wood, for example, to be easily added to the pan 17, makes the task of lighting the fuel easy to perform, allows lit fuel in the pan 17 to easily be tended to, and allows easy removal, dumping and cleaning of the pan 17 and drawer 19. The drawer 19 has a handle 41a attached thereto that can be gripped by the fingers of a user to slide the drawer 19 open and closed. The bottom surface 41b of the drawer 19 is vented to allow air from the independently-controlled air vents (not shown) below the drawer 19 to flow upward into the drawer 19.

As can be seen in FIGS. 8 and 9, in accordance with this embodiment, the handle 45 for the main door 23 of the oven 1 is attached to the encasement 3 by mounting posts 45a and 45b that are directed outwardly and upwardly relative to the front surface 23a of the door 23. The door 23 is coupled on its lower edge to the encasement 3 by hinges 48a and 48b (FIG. 9) that allow the door 23 to rotate between the opened and closed positions. The outwardly and upwardly directed handle 45 results in the handle 45 being easily accessible to the user even when the door 23 is in the fully open position shown in FIG. 9. A temperature gauge 49 is disposed on the front surface of the door 23 for displaying the temperature of the oven inside of the cooking chamber 5.

As shown in FIG. 9, the inside of the door 23 preferably has a gasket 46 that is complementary in shape and size to the main opening 47 of the oven 1. When the door 23 is in the closed position, the gasket 46 seals the opening 47. The gasket 46 promotes low and slow cooking by strictly limiting the entry of oxygen into the cooking chamber 5.

With reference to FIGS. 10-12, in accordance with this representative embodiment, the elevation racks 13 on opposite sides of the cooking chamber 5 have downwardly-directed bends 51 formed therein toward the front of the cooking chamber 5 near the opening 47 that acts as stops to prevent the shelves 12 and 14 from being pulled completely out of the oven 1. The bends 51 act as stops in that they come into abutment with rails 52 and 53 that extend across the rear edges of the shelves 12 and 14, respectively, to prevent further movement of the shelves 12 and 14 in the forward direction out of the oven 1. This allows the shelves 12 and 14 to remain horizontal and balanced as shown in FIG. 12 when the bends 51 are in abutment with the rails 52 or 53 in the positions shown in FIG. 12.

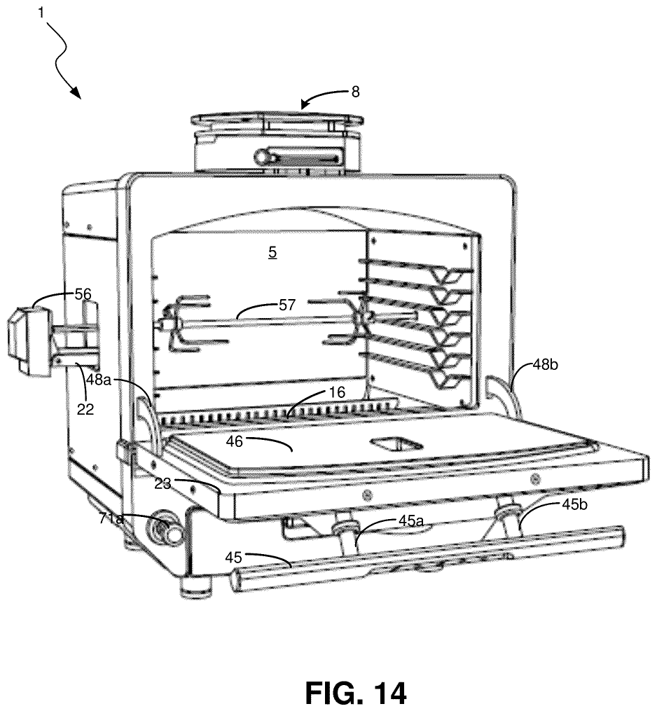

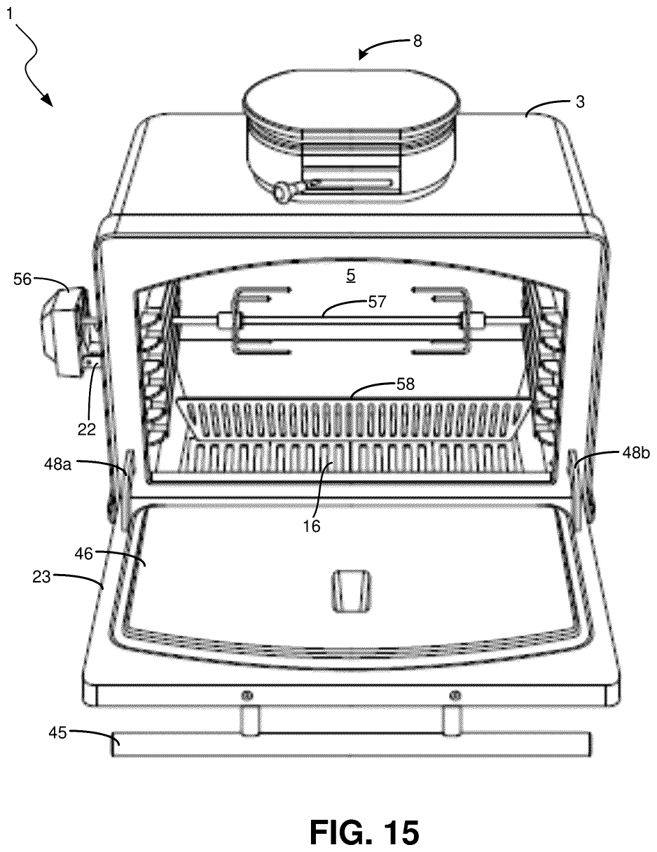

The rotisserie configuration of the cooking oven 1 will now be described with reference to FIGS. 13-15. FIG. 13 shows a side perspective view of the cooking oven 1 shown in FIG. 1 showing one of the fold-out doors 22 having an adapter plate 55 for attachment to a rotisserie motor 56 when the oven is to be used for rotisserie cooking. The adapter plate 55 preferably is a universal adapter plate such that virtually any rotisserie motor of any type can be attached to the plate 55. FIG. 14 shows a front perspective view of the cooking oven 1 shown in FIG. 1 in accordance with a representative embodiment with the front door 23 of the oven 1 in the open position to show a rotisserie spit 57 having ends that pass thru ports 21 (FIG. 3) disposed in opposite sides of the encasement 3 and the rotisserie motor 56 attached to one of the ends of the spit 57. FIG. 15 shows a top perspective view of the cooking oven 1 shown in FIG. 14 in accordance with a representative embodiment with the front door 23 of the oven in the open position to show a vertical divider 58 slotted into openings formed in the charcoal grates 16 to allow charcoal to be piled up in a rear portion of the oven 1 beneath the spit 57 for rotisserie cooking.

When the fold-out doors 22 are unfolded into the horizontal position shown in FIG. 13, the adapter plate 55 can be unfolded as shown into the vertical position shown in FIG. 13. The rotisserie motor 56 can then be mounted on the adapter plate 55 and coupled to an end of the spit 57 for rotating the spit 57. The fold-out doors 22 are attached by respective hinge mechanisms to the encasement 3 and the adapter plates 55 are attached by respective hinge mechanisms to the doors 22. After rotisserie cooking, the motor 56 and spit 57 can be removed and the fold-out doors 22 returned to their folded positions flush against the side surfaces of the encasement 3.

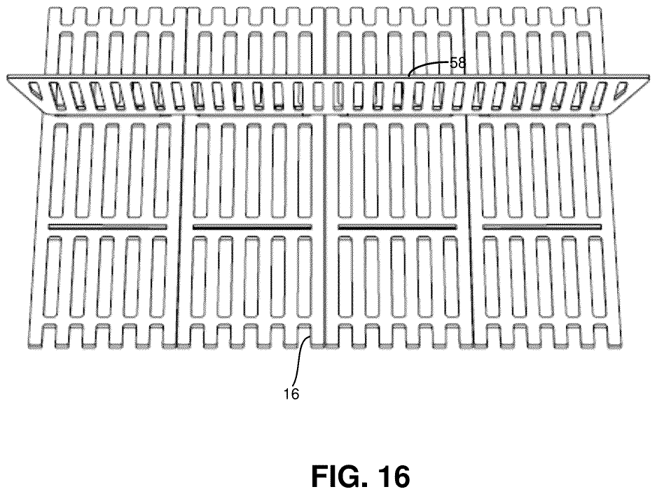

FIG. 16 shows a top perspective view of the vertical divider 58 slotted into the charcoal grates 16 as shown in FIG. 15 for piling up charcoal in the back portion of the oven. The vertical divider 58 can have slots formed in it similar to the slots formed in the grates 16 for allowing air and smoke to pass through the divider 58. The divider 58 prevents charcoal disposed on the grates 16 in between the divider 58 and the rear wall of the cooking chamber 5 from tumbling past the divider 58 onto parts of the grates 16 on the opposite side of the divider 58.

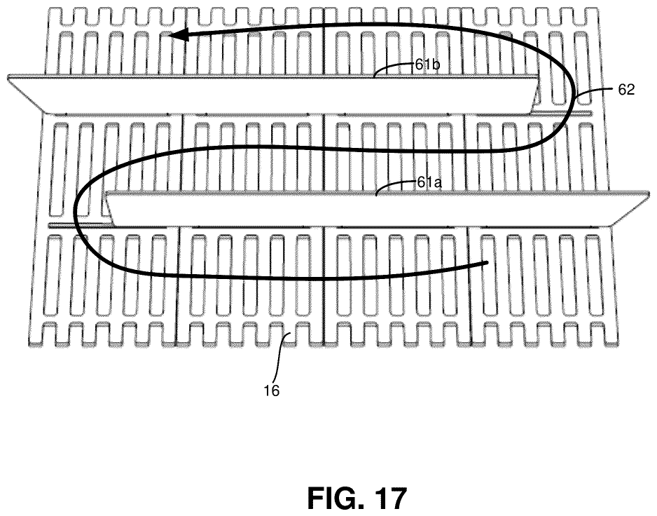

FIG. 17 shows a top perspective view of two vertical dividers 61a and 61b slotted into the grates 16 for piling up fuel (e.g., charcoal) on different portions of the grates 16 for prolonged cooking. This configuration can be used, for example, to perform a cooking method known as the snake method by piling up snake-like configuration of unlit charcoal briquettes on the grates 16 around the dividers 61a and 61b as indicated by arrow 62 and then placing a few lit briquettes at one end of the “snake”. This allows the user to maintain a consistent low temperature for a long period of time (i.e., low and slow) as the lit briquettes gradually light the unlit briquettes.

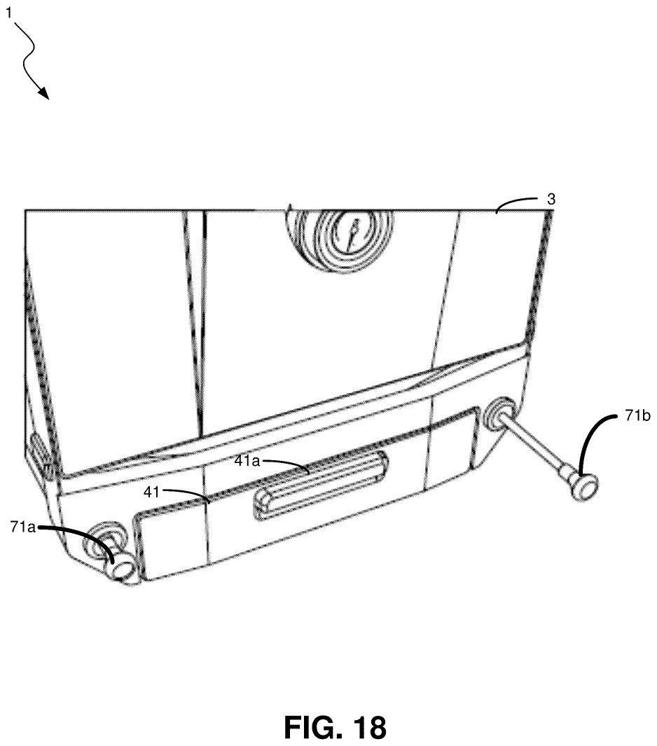

FIG. 18 shows a lower portion of the front perspective view of the cooking oven 1 shown in FIG. 1 that first and second control levers 71a and 71b, respectively, for independently controlling airflow to opposite sides of the oven 1. FIG. 19 shows a bottom perspective view of the oven 1 that shows first and second air vents 72a and 72b, respectively, that are controlled by the first and second control levers 71a and 71b, respectively, shown in FIG. 18 for providing independently-controlled airflows to opposite sides of the cooking chamber 5. FIG. 20 shows a front cross-sectional view of the cooking oven 1 shown in FIG. 1 in accordance with a representative embodiment taken along line A-A′ showing air flowing in a generally circular vortex 75 created by indirect heating with the deflector elements 15a and 15b in combination with using the control levers 71a and 71b to precisely control airflow of the heat and smoke from the lit charcoal contained in the pull-out drawer 19.

Proximal ends of the control levers 71a and 71b are disposed outside of the encasement 3 for access by a user while the distal ends of the levers 71a and 71b are mechanically coupled to the air vents 72a and 72b. The air vents 72a and 72b are rotationally mounted on the bottom surface of the encasement 3 such that pull and push forces exerted on the proximal ends of the levers 71a and 71b are translated into rotating motion of the air vents 72a and 72b, respectively. Pushing the control lever 71a or 71b in towards the cooking chamber 5 as far as possible until it abuts a stop (not shown) completely closes the air vent 72a and 72b, respectively, by misaligning openings formed in the air vents 72a and 72b with openings formed in the bottom surface of the encasement 3. Conversely, pulling the control lever 71a or 71b out as far as possible until it abuts a stop (not shown) completely opens the air vent 72a and 72b, respectively, by aligning openings formed in the air vents 72a and 72b with openings formed in the bottom surface of the encasement 3. When the control lever 71a or 71b is pushed in all of the way until it abuts a stop (not shown) such that the air vent 72a or 72b, respectively, is completely closed, pulling the lever 71a or 71b outwardly increasingly opens the air vent 72a or 72b, respectively. Conversely, when the control lever 71a or 71b is pulled out all of the way until it abuts a stop (not shown) such that the air vent 72a or 72b, respectively, is completely open, pushing the lever 71a or 71b inwardly increasingly closes the air vent 72a or 72b, respectively.

In FIG. 19, control lever 71a is pushed in to its farthest extent, thereby placing the air vent 71b in the completely closed position, whereas control lever 71b is pulled out to its farthest extent, thereby placing the air vent 71b in the completely open position. As can be seen, the two levers 71a and 71b independently control the air vents 72a and 72b, respectively, which are located beneath the bed of charcoal disposed in the pan 17 inside of the pull-out drawer 41. This allows for two-zone cooking, but it provides another important application when it comes to low and slow cooking. When charcoal is piled up under one of the heat deflector elements 15a or 15b and the corresponding vent 72a or 72b underneath the remaining heat deflector element 15a or 15b is placed in the completely open position, it creates a generally circular vortex 75 of indirect heat inside of the cooking chamber 5 that circles around food located above the heat deflector on the shelf 12, as shown in FIG. 20. This is the ideal set-up for low and slow grilling or cooking.

It should be noted that in accordance with the preferred embodiment, multiple removable deflector elements 15a, 15b are removably positioned on the shelf 14. A variety of cooking configurations can be achieved by removing one or more of the deflector elements, piling coal up beneath the remaining deflector element(s), and adjusting the extent to which the air vents 72a and 72b are open or closed.

As seen in the figures, the outdoor cooking oven 1 generally has a shape, form factor and other features that in some ways resemble features of an in-door cooking range. For example, the oven 1 is generally cubic in shape, has a front door 1 that is hinged along its bottom edge to allow it to rotate downwardly and upwardly to open and close the oven 1, respectively, and has shelves 12 and 14 that can be pulled outwardly and pushed inwardly to access whatever is placed on the shelves 12 and 14. While these features are preferred, they are not required and many modifications can be made within the scope of the present disclosure. Also, while first and second side-by-side air vents 72a and 72b, respectively, first and second side-by-side heat deflector elements 15a and 15b, respectively, and first and second control levers 71a and 71b, respectively, are shown and described, any suitable number heat deflector elements, air vents and control levers can be used. Also, although only two shelves 12 and 14 are shown in the figures, the oven 1 can be configured to accommodate any suitable number of shelves.

It should be noted that the illustrative embodiments have been described with reference to a few embodiments for the purpose of demonstrating the inventive principles and concepts. Persons of skill in the art will understand how the principles and concepts of the invention can be applied to other embodiments not explicitly described herein. For example, while a particular configuration of the oven 1 is described herein and shown in the figures, a variety of other configurations can be used, as will be understood by those skilled in the art in view of the description provided herein. Many other modifications may be made to the embodiments described herein while still achieving the goals of the present disclosure, and all such modifications are within the scope of the invention.

What is claimed is:

1. An outdoor cooking oven, comprising:
a cooking chamber accessible to a user by one or more exterior doors and defining a left-side cooking zone and a right-side cooking zone interior to the oven;
one or more cooking racks positioned within the cooking chamber and spanning the left-side cooking zone and the right-side cooking zone;
an indirect heating shelf positioned beneath the one or more cooking racks;
a fuel grate positioned beneath the indirect heating shelf;
a pair of rotatable vents positioned beneath the fuel grate and associated, respectively, with the left-side cooking zone and the right-side cooking zone; and
an ash drawer positioned beneath the pair of rotatable vents such that ash produced from combusted fuel on the fuel grate is captured in the ash drawer after gravitationally falling through the pair of rotatable vents;
wherein the pair of rotatable vents are individually adjustable by push-pull levers accessible to a user on a front surface of the cooking oven such that air flow introduced through the rotatable vents is directed individually through a fuel bed combusting on the fuel grate to the left-side and/or right-side cooking zones.

2. The outdoor cooking oven of claim 1, wherein the indirect heating shelf further comprises one or more removable ceramic heat deflectors.

3. The outdoor cooking oven of claim 2, wherein the one or more ceramic heat deflectors comprise a series of vents positioned around the outer edge.

4. The outdoor cooking oven of claim 1, wherein the pair of rotatable vents are respectively positioned in concave regions of a supporting surface.

5. The outdoor cooking oven of claim 1, wherein the fuel grate comprises one or more vertical dividers operable to divide a fuel bed.

6. The outdoor oven of claim 1, further comprising a chimney positioned above the cooking chamber and defining a tortuous path for an airflow exiting the cooking chamber.

7. The outdoor oven of claim 6, wherein the tortuous path is configured to capture grease entrained in an airflow exiting the cooking chamber.

8. The outdoor oven of claim 6, wherein the chimney is comprised of a base, a removable grease bowl, and a removable cap.

9. The outdoor oven of claim 6, wherein the chimney comprises an adjustable vent for controlling an airflow exiting the cooking chamber.

10. The outdoor oven of claim 1, further comprising a temperature gauge positioned on the one or more exterior doors.

11. An outdoor cooking oven, comprising:
a cooking chamber accessible to a user by one or more exterior doors and defining a left-side cooking zone and a right-side cooking zone interior to the oven;
one or more cooking racks positioned within the cooking chamber and spanning the left-side cooking zone and the right-side cooking zone;
an indirect heating shelf positioned beneath the one or more cooking racks;
a fuel grate positioned beneath the indirect heating shelf;
a pair of rotatable vents positioned to allow an incoming airflow beneath the fuel grate, wherein each of the rotatable vents is associated, respectively, with the left-side cooking zone and the right-side cooking zone; and
an ash drawer positioned beneath the fuel grate such that ash produced from combusted fuel on the fuel grate is captured in the ash drawer;
wherein the pair of rotatable vents are individually adjustable such that air flow introduced through the rotatable vents is directed individually through a fuel bed combusting on the fuel grate to the left-side and/or right-side cooking zones.

12. The outdoor cooking oven of claim 11, wherein the indirect heating shelf further comprises one or more removable ceramic heat deflectors.

13. The outdoor cooking oven of claim 12, wherein the one or more ceramic heat deflectors comprise a series of vents positioned around the outer edge.

14. The outdoor cooking oven of claim 11, wherein the pair of rotatable vents are respectively positioned in concave regions of a supporting surface.

15. The outdoor cooking oven of claim 11, wherein the fuel grate comprises one or more vertical dividers operable to divide a fuel bed.

16. The outdoor oven of claim 11, further comprising a chimney positioned above the cooking chamber and defining a tortuous path for an airflow exiting the cooking chamber.

17. The outdoor oven of claim 16, wherein the tortuous path is configured to capture grease entrained in an airflow exiting the cooking chamber.

18. The outdoor oven of claim 16, wherein the chimney is comprised of a base, a removable grease bowl, and a removable cap.

19. The outdoor oven of claim 16, wherein the chimney comprises an adjustable vent for controlling an airflow exiting the cooking chamber.

20. The outdoor oven of claim 11, further comprising a temperature gauge positioned on the one or more exterior doors.
